(19) United States
(12) Patent Application Publication
(10) Pub. No.: US 2026/0145213 A1
(43) Pub. Date: May 28, 2026

(54) SELF-CLEANING PRESSURE LOADING SYSTEM

(71) Applicant: Erlenbach GmbH, Lautert (DE)

(72) Inventor: Lars SPRISTERSBACH, Himmighofen (DE)

(21) Appl. No.: 19/121,932

(22) PCT Filed: Oct. 11, 2023
(86) PCT No.: PCT/EP2023/078219

§ 371 Date: Apr. 17, 2025

(30) Foreign Application Priority Data
Oct. 21, 2022 (DE) 10 2022 127 900.6

(51) Int. Cl. B08B 9/08; B01J 8/02

(52) U.S. Cl. CPC B08B 9/0804; B01J 8/02; B01J 2208/00769; B08B 2209/08

(57) ABSTRACT

The invention relates to a pressure loading system (1) comprising a pressure loading tank (20) having a longitudinal axis (A), which has a pressure container wall (22) with an inner surface (24) bounding a cavity (26) and which has an inlet section (12), a central section (14) and an outlet section (16) along the longitudinal axis (A), comprising a particle inlet (10) which defines an inlet opening (28) in the inlet section (12), and a particle outlet (18) which defines an outlet opening (30) in the outlet section (16), and comprising a gas supply line (44) opening into the cavity (26) in the inlet section (12), which is configured to introduce a gas stream (2) into the cavity (26), in such a manner that the gas stream (2) in the cavity (26) is set into rotation about the longitudinal axis (A).

### CROSS-REFERENCE TO RELATED APPLICATIONS

This application is the U.S. national stage application of International Patent Application No. PCT/EP 2023/078219, filed Oct. 11, 2023, which claims the benefit under 35 U.S.C. § 119 of German Application No. 10 2022 127 900.6, filed Oct. 21, 2022, the disclosures of each of which are incorporated herein by reference in their entirety.

The invention relates to a pressure charging system comprising a pressure charging tank having a longitudinal axis, which pressure charging tank comprises a pressure vessel wall with an inner surface circumscribing a cavity and which has an inlet section, a center section and an outlet section along the longitudinal axis, with a particle inlet defining an inlet opening in the inlet section and a particle outlet defining an outlet opening in the outlet section. The invention also relates to a method for cleaning a pressure charging tank comprising a longitudinal axis, the pressure charging tank comprising a pressure vessel wall with an inner surface circumscribing a cavity and having an inlet section, a center section and an outlet section along the longitudinal axis.

The background to the present invention is the pre-foaming of expandable particles by means of infrared radiation. In contrast to steam pre-foaming, this so-called dry expansion offers the possibility of rapid material changeover, as the system can be cleaned relatively quickly. This type of pre-foaming unit is interesting for particles that do not themselves contain a blowing agent, such as EPP. In order to enable pre-foaming of such particles, an increased internal pressure of the particles is required instead of the blowing agent. For this purpose, the particles are loaded with a pressurized gas in the pressure charging system. This takes place in a process or pressure charging tank, in which the gas pressure is slowly increased after the particles have been introduced. This can take place with simultaneous heating of the tank interior or without heating. Depending on other factors, the process without heating takes in the order of days. If heat is added, the process can take place within a few hours. The loaded particles are then either transferred to a storage tank or stored in the process tank, in which a constant, increased pressure is maintained so that the particles can be stored for a longer period of time. For further processing, the particles are transported to a pre-foaming unit. Transportation should be relatively quick so that the pressure in the particles does not build up. For this purpose, the transport can also be carried out directly to the pre-expander in a transport line under increased pressure. In the dry pre-expander, the particles are heated by infrared radiation and expand to a predetermined size due to the increased internal pressure.

One problem with such expandable particles is that they tend to adhere to the inner surface of the pressure vessel wall. As a result, particles can remain in the pressure charging tank after emptying. This is a particular problem before each material change. In the event of a material change with a color change or a change to particles with different dimensions or properties, for example, the particles left behind can become clearly visible as foreign bodies in the finished foamed product. For this reason, the pressure charging tank must be cleaned before each material change.

Cleaning is carried out by means of cleaning lances, which are inserted through a cleaning opening in the pressure charging tank. Gas is blown into the tank through the lances under high pressure, wherein the lances are manually guided in order to remove particles from as many areas of the inner surface as possible.

It should be added that the invention is not limited to applications in which the pre-foaming of expandable particles is carried out by means of infrared radiation. This technology was mentioned at the beginning because it provided the impetus for the present invention. However, the invention can also be combined with subsequent steam pre-foaming, for example. Against this background, the object is to largely automate the cleaning process in general.

The object is achieved by a pressure charging system according to claim 1 and by a method according to claim 20.

The invention provides that, in a pressure charging system of the type mentioned above, a gas supply opening into the cavity in the inlet section is provided, which is arranged to introduce a gas flow, preferably air flow, into the cavity in such a way that the gas flow in the cavity is set in rotation about the longitudinal axis.

Accordingly, the method according to the invention comprises the step of introducing a gas flow into the cavity in the inlet section, wherein the gas flow in the cavity is set into rotation about the longitudinal axis.

The invention makes use of the geometry of the pressure charging tank by providing a gas supply which is arranged and configured relative to the pressure vessel wall, preferably in a fixed position, in such a way that the gas flow moves along the inner surface, rotating about the longitudinal axis, from the inlet section to the outlet section, thereby passing along the largest possible surface area of the inner surface at a high relative speed.

The pressure charging system is understood herein in particular to be a system arranged to provide gas under sufficient pressure. Accordingly, pressure charging tank means a tank comprising a sufficient pressure resistance. Currently, pressures of a maximum of 6 to 10 bar are common. Wherever the term “pressure” is used or values are given, this refers to the overpressure relative to atmospheric or air pressure. However, in view of even larger particle volumes, much higher pressures of up to 50 bar or more may be used in the future. The pressure charging system should at least be arranged to provide gas at a pressure of at least 1 bar, preferably at least 3 bar, and the pressure charging tank should accordingly comprise a pressure resistance of at least 1 bar, preferably at least 3 bar. In order to be able to withstand such pressures with a tank volume of 200 liters or more, sufficient for production standards, tank wall thicknesses of preferably at least 5 mm, particularly preferably at least 8 mm should be provided. As an alternative and/or in addition to high wall thicknesses, stiffening elements such as beads, folds, bands running around the container wall in the circumferential direction or ribs running along the container wall in the longitudinal direction and the like are preferable.

Preferably, the pressure charging tank comprises a maximum internal cross-sectional area in the center section perpendicular to the longitudinal axis. In other words, the pressure charging tank is thickest in the center section.

Furthermore, the center section is preferably cylindrical in shape. A circular cylindrical shape is particularly preferred in terms of manufacturing technology.

The inlet section advantageously comprises an internal cross-sectional area perpendicular to the longitudinal axis, which increases continuously along the longitudinal axis from the inlet opening to the center section. In other words, the inlet section advantageously widens along the longitudinal axis from the inlet opening to the center section in the shape of a funnel. A particularly preferred embodiment of the funnel-shaped widening inlet section is a conical widening.

Accordingly, the outlet section preferably comprises an inner cross-sectional area perpendicular to the longitudinal axis, which decreases continuously along the longitudinal axis from the center section to the outlet opening. In other words, the outlet section preferably tapers along the longitudinal axis from the center section to the outlet opening in the shape of a funnel or, again in a particularly preferred embodiment, in the shape of a cone.

A cylindrical center section as well as a conically widening inlet section and a conically tapering outlet section are preferred for manufacturing reasons, as these simple geometries can be produced with simple tools and blanks made of sheet material.

It is also advantageous for the inner surface in the inlet section to comprise a maximum funnel opening angle βₑ≤45°, preferably βₑ≤35°, plotted against the longitudinal axis. Larger funnel opening angles mean that the cavity in the inlet section expands too quickly. As a result, the gas flow introduced into the cavity is not deflected sufficiently in a tangential direction with respect to the longitudinal axis, which has an unfavorable effect on the formation of a rotational flow. Furthermore, the inner surface in the inlet section preferably comprises a minimum funnel opening angle βₑ≥20°, preferably βₑ≥25°, plotted against the longitudinal axis. A small funnel opening angle limits the volume of the pressure charging tank too much for a given overall length.

The inner surface in the outlet section also preferably comprises a maximum funnel opening angle of βₐ<45°, preferably βₐ≤35°, plotted against the longitudinal axis. Similar considerations apply here as for the inlet section, wherein the maximum funnel opening angle in the outlet section can preferably be configured to be somewhat more acute, thus taking into account a weakening of the gas flow caused by the wall friction in the direction of the outlet section.

The maximum funnel opening angle is understood to be the largest angle that a tangent lying in a radial plane covers on the inner surface in the inlet section or in the outlet section, plotted between the inner wall of the container and the longitudinal axis. In the case of a conical taper or widening, the maximum funnel opening angle corresponds to the constant funnel opening angle in the radial plane.

Preferably, the outlet section tapers more acutely along the longitudinal axis than the inlet section widens along the longitudinal axis. In other words, it is preferred if the maximum funnel opening angle βₐ in the outlet section and the maximum funnel opening angle βₑ in the inlet section comprise the following relationship βₐ≤Bₑ. Particularly preferred is βₐ<βₑ and especially preferred is βₐ<Bₑ−3.

A weakening of the flow from the inlet section to the outlet section can thus be compensated for reasonably well.

It has been found that the best cleaning results can be achieved when the gas supply opens into the inlet section through the inlet opening. Alternatively, the gas supply can also open into the inlet section tangentially and in a direction away from the inlet section towards the outlet section below, with respect to the longitudinal axis, of the inlet opening. In this case, it is preferred if the gas supply comprises at least two or more openings into the inlet section. The gas supply through the inlet opening of the particle inlet has the advantage that the gas flow already passes through the particle inlet on the same path as the particles to be filled in, so that any residues in this area can also be captured and swept away by the gas flow.

This embodiment can be realized particularly preferably by the gas supply comprising a gas guiding element arranged at least partially in the particle inlet. The gas flow is set in rotation by means of the gas guiding element.

The gas guiding element advantageously comprises at least two gas guide vanes arranged symmetrically around the longitudinal axis.

Preferably, the particle inlet is designed as a port coaxial to the longitudinal axis. In this case, the gas guide vanes extend advantageously in a radial direction from the longitudinal axis to an inner surface of the particle inlet, wherein they form an outer vane edge along the inner surface of the particle inlet, which is inclined at least in sections with respect to the direction of the longitudinal axis. This geometry results in a vane shape that forces a tangential movement component onto the incoming gas.

It is particularly preferable for the outer edge of the vane to form a curved shape with an increasing angle of inclination in the direction from the inlet opening to the outlet opening in relation to the direction of the longitudinal axis. A gas guiding element with gas guide vanes configured in this way has proven to be advantageous compared to gas guide vanes with a straight outer edge in terms of improved deflection of the gas flow in the circumferential direction.

Particularly preferred is a maximum angle of inclination of the outer vane edge at its end on the outlet side in the axial direction relative to the direction of the longitudinal axis of 30° or more, especially preferably 40° or more and very particularly preferably 45° or more.

In combination with one or more of the aforementioned features, the pressure charging system is advantageously configured further in that the ratio of the cross-sectional area of the inlet opening to the maximum internal cross-sectional area is ≥1.5:100.

A geometry of the pressure charging tank is also preferably configured further such that the ratio of the square root of the maximum internal cross-sectional area Fmax to a length L of the pressure charging tank along the longitudinal axis from the inlet opening to the outlet opening is 0.2≤\sqrt{Fₘₐₓ}/L≤0.8.

A particularly advantageous embodiment of the pressure charging system provides that a shear stress of at least 1 Pa, preferably at least 5 Pa and particularly preferably at least 10 Pa, can be generated by means of the rotating gas flow over a surface area of at least 80%, preferably at least 85%, particularly preferably at least 90% of the inner surface and at a distance of 1 mm from the inner surface.

Accordingly, the method according to the invention is advantageously configured in such a way that a shear stress of at least 1 Pa, preferably at least 5 Pa and particularly preferably at least 10 Pa, is generated by means of the rotating gas flow over an area of at least 80%, preferably at least 85%, particularly preferably at least 90% of the inner surface and at a distance of 1 mm from the inner surface.

The method is further advantageously configured in that the cavity comprises a volume V and the inner surface comprises a dimension F, wherein the gas flow, preferably an air flow, is introduced under an inlet pressure P of 3 to 12 bar, preferably 6 to 10 bar, and/or a mass flow S of 20 to 100 kg/s. Preferably, the gas flow is introduced under these conditions for at least 0.5 seconds, particularly preferably at least 1 second and/or for at most 5 seconds, particularly preferably at most 3 seconds.

Accordingly, the pressure charging system advantageously comprises a gas pressure source, preferably a compressed air source, which can be connected to the gas supply of the gas charging tank and which is arranged to provide an air flow at an inlet pressure P of 3 to 12 bar, preferably 6 to 10 bar. Here, too, the overpressure relative to atmospheric or air pressure is meant. Furthermore, the gas pressure source is preferably arranged to provide a gas flow with a mass flow rate S of 20 to 100 kg/s. These values have proven to be advantageous for generating the above shear stress values in most cases.

Preferably, the gas pressure source is arranged to provide the gas flow for at least 0.5 seconds, particularly preferably at least 1 second. It has been shown that this duration is generally sufficient to completely empty the tank and free it of adhering particles.

Furthermore, the gas pressure source is preferably arranged to provide the gas flow for a maximum of 30 seconds, preferably a maximum of 5 seconds, particularly preferably a maximum of 3 seconds. This makes it possible to limit the gas consumption and thus the dimensions of the gas pressure source.

In a preferred embodiment, the gas pressure source comprises a discontinuous gas pressure source such as a gas pressure accumulator, in particular a compressed air accumulator. Gas pressure accumulators or discontinuous gas pressure sources in general have the advantage that they can provide a large mass flow at a high pressure. At the same time, the gas pressure accumulator can be loaded with a comparatively low volume or mass flow because cleaning is only repeated at long intervals. A small, cost-effective compressor is therefore generally sufficient.

Alternatively, a continuous gas pressure source, such as a blower, can also be provided as a compressed air source. This can also be used to generate a large mass flow relatively inexpensively. However, the pressures that can be generated are comparatively low, which means that the cleaning process can take longer.

With discontinuous gas pressure sources, the provision of the gas flow can be limited in time, for example, simply by dimensioning the gas pressure accumulator. Continuous gas pressure sources can be switched on or off as required. Regardless of the type of gas pressure source. The pressure charging system preferably comprises a switching element for switchable interruption of the air flow. Such a switching element can, for example, be realized as a valve arrangement, flap arrangement or the like.

The method also preferably provides for the gas loading tank to be earthed. Accordingly, the gas loading tank comprises an electrical ground connection. This can reduce the number of adhering particles and thus the need for cleaning from the outset.

The method is advantageously configured further in that the introduction of a gas stream into the cavity comprises the introduction of an ionized gas, in particular ionized air. Accordingly, the pressure charging system advantageously comprises a gas or air ionizer connected to the gas supply.

Further advantages and features of the invention are explained below with reference to examples shown in the figures. It is shown in:

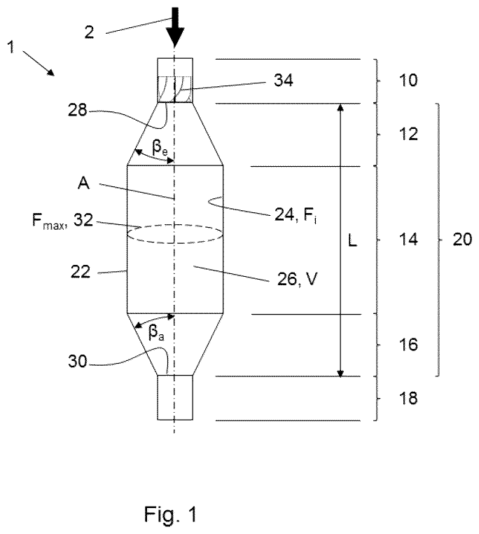

FIG. 1 The pressure charging system according to a first embodiment of the invention in sectional view from the side;

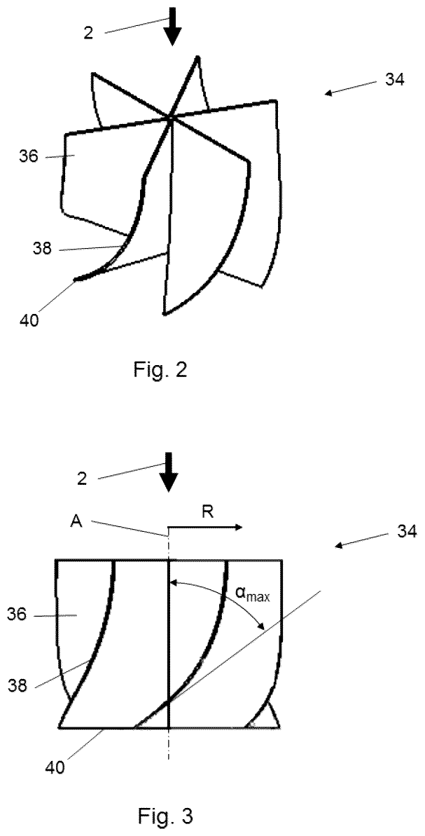

FIG. 2 a gas guiding element in perspective view, as installed in the pressure charging system according to FIG. 1;

FIG. 3 a side view of the gas guiding element;

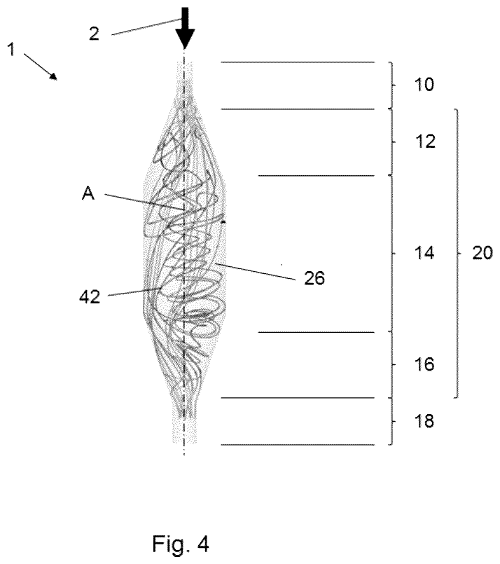

FIG. 4 a schematic representation of the pressure charging system according to FIG. 1 with the flow path of an introduced gas stream shown;

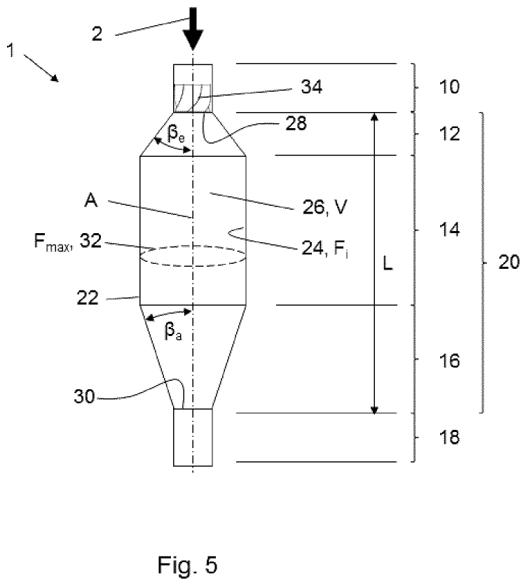

FIG. 5 a second embodiment of the pressure charging system according to the invention in sectional side view;

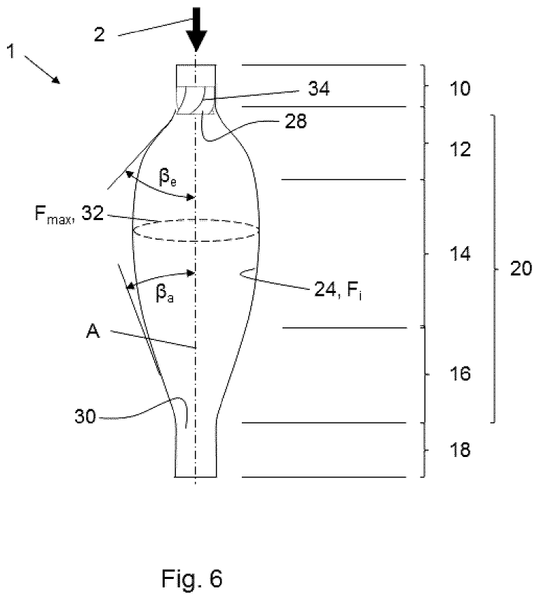

FIG. 6 a third embodiment of the pressure charging system according to the invention in sectional side view;

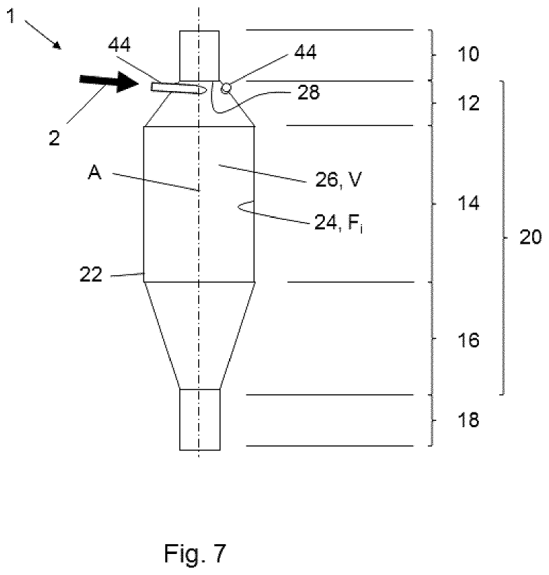

FIG. 7 a fourth embodiment of the pressure charging system according to the invention in side view with modified gas supply and

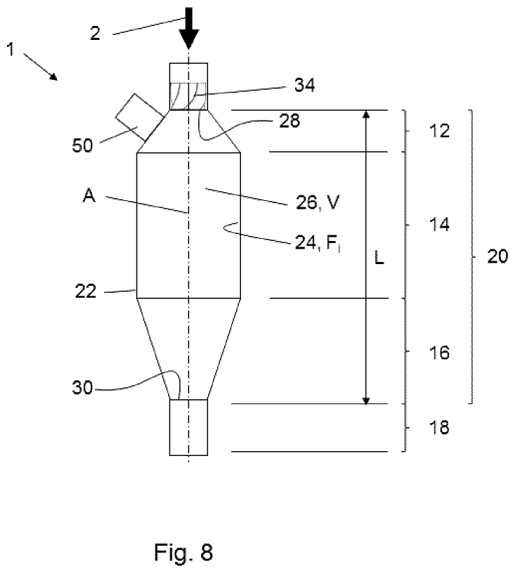

FIG. 8 a fifth embodiment of the pressure charging system according to the invention in side view with modified particle inlet.

FIG. 1 shows a first embodiment of the pressure charging system 1 according to the invention, comprising a longitudinal axis A. All the components described below are essentially rotationally or angularly symmetrical around this axis. These are, in the direction of flow of the gas stream, characterized by the arrow 2, a particle inlet 10, an inlet section 12, a center section 14, an outlet section 16 and a particle outlet 18. Not shown are, for example, inspection windows or feed-through windows for any probes for process monitoring and the like, which can also be arranged laterally at one of the aforementioned sections, inlets or outlets and thus cancel out the rotational or angular symmetry. “Essentially” is to be understood here as meaning that the embodiments in particular, as well as the invention in general, also extend in this sense to pressure charging systems whose pressure charging tank comprises a rotationally or angularly symmetrical basic shape, but which is not completely rotationally or angularly symmetrical due to connections and functional attachments or internals.

The inlet section 12, the center section 14 and the outlet section 16 together form a pressure charging tank 20 with a common pressure vessel wall 22, the inner surface 24 of which circumscribes a cavity 26. The particle inlet 10 as well as the particle outlet 18 are each designed as ports coaxial to the longitudinal axis A. The particle inlet 10 defines an inlet opening 28 in the inlet section 12. Similarly, the particle outlet 18 defines an outlet opening 30 in the outlet section 16. The particles to be pressure-charged are introduced into the pressure charging tank 20 through the particle inlet and the pressure-charged particles are withdrawn from the pressure charging tank 20 through the particle outlet.

The pressure charging tank 20 comprises a maximum internal cross-sectional area 32 in the center section 14 perpendicular to the longitudinal axis A. Since in this embodiment the center section 14 comprises a circular cylindrical geometry over its entire length, the cross-sectional area 32 is constant over its entire length. The inlet section 12 comprises an internal cross-sectional area perpendicular to the longitudinal axis A, which increases continuously along the longitudinal axis A from the inlet opening 28 to the center section 14. In the present case, the inlet section 12 widens along the longitudinal axis A from the inlet opening 28 to the center section in the shape of a cone. Mirroring this, the outlet section 16 comprises an internal cross-sectional area perpendicular to the longitudinal axis A, which decreases steadily along the longitudinal axis A from the center section 14 to the outlet opening 30. Specifically, in the shown initial example, the outlet section 16 also tapers conically along the longitudinal axis A from the center section 14 to the outlet opening 30. Accordingly, the inner surface 24 in the inlet section 12 can be parameterized by a constant funnel opening angle βₑ, which spans between the longitudinal axis A and the inner surface 24. The same applies to the outlet section 16, whose inner surface 24, plotted against the longitudinal axis A, comprises a constant funnel opening angle βₐ. In the present embodiment shown in FIG. 1, the funnel opening angle βₑ of the inlet section 12 and the funnel opening angle βₐ of the outlet section 16 are the same.

A gas guiding element 34 is arranged in the particle inlet 10, which will be explained in more detail below with reference to FIGS. 2 and 3. The gas guiding element 34 is part of a gas supply which, in addition to the gas guiding element, may comprise, for example, a gas feedthrough, a gas connection for a gas line and/or a valve for limiting the pressure and/or the volume flow of the gas flow (not shown). In the embodiment shown, the gas supply opens through the inlet opening 28 in the inlet section 12 into the cavity 26 of the pressure charging tank 20. The particles to be introduced into the pressure charging tank 20 through the particle inlet are transported through the gas guiding element. This ensures that the gas already travels the same path as the particles before reaching the cavity 26 during the subsequent cleaning, so that the cleaning also includes parts of their transport path.

FIGS. 2 and 3 show an enlarged view of the gas guiding element 34. In the embodiment shown in FIG. 1, it is arranged completely in the particle inlet 10. However, it can also be arranged offset in the direction of the gas flow 2, i.e. in the downward direction, projecting into the inlet section 12. Local prepositions such as “below”, “under”, “above” or “over” herein refer to the direction of gravity, which in the embodiments shown here coincides with the direction of flow of the gas stream 2. The gas guiding element 34 comprises a total of six gas guide vanes 36 arranged rotationally or axially symmetrically about the longitudinal axis A. The gas guide vanes 36 extend in radial direction R from the longitudinal axis A to the inner surface of the particle inlet 10, wherein they form an outer vane edge 38 along this inner surface of the particle inlet 10, which is inclined relative to direction A at least in sections. More precisely, in the embodiment of the gas guiding element 34 shown here, the outer vane edge 38 forms a curved curve with an increasing angle of inclination a relative to the direction of the longitudinal axis A in the direction from the inlet opening 28 to the outlet opening 30, wherein the angle α defines the acute angle plotted relative to the longitudinal axis A to the tangent to the curved curve of the outer vane edge 38. At its outlet-side end 40 in the axial direction, the maximum angle of inclination αₘₐₓ relative to the direction of the longitudinal axis A is 50° in the embodiment shown here. The outlet-side or lower end 40 of the outer vane edge 38 is arranged in the plane of the inlet opening 28 in the initial example of FIG. 1.

FIG. 4 shows the result of a mathematical simulation of the pressure charging system 1 according to the embodiment of FIG. 1. A gas flow 2 introduced through the gas supply opening into the cavity 26 in the inlet section 12 is caused to rotate about the longitudinal axis A in the cavity 26 by means of the gas guiding element 34 arranged in the particle inlet 10. This is indicated in the simulation by spiral flow lines 42. The simulation showed that in this embodiment, a shear stress of at least 10 Pa can be generated by means of the rotating gas flow over an area of >80% of the inner surface 24, at a distance of 1 mm from the inner surface 24.

FIG. 5 shows a second embodiment of the pressure charging system according to the invention, which essentially differs from the first embodiment according to FIG. 1 in that the inlet section 12 and the outlet section 16 each comprise a different geometry, which also changes the overall geometry of the pressure vessel wall 22, the cavity 26 and the inner surface 24. Specifically, the inlet section 12 and the outlet section 16 are each still truncated cones, wherein in this case the maximum funnel opening angles of the inlet and outlet sections 12, 16 are βₑ=30° and βₐ=20° and βₐ=Bₑ−10°, respectively.

In this example, a simulation of the flow pattern within the cavity 26 showed that the optimized geometry at a distance of 1 mm from the inner surface 24 allows a shear stress of at least 10 Pa to be generated over an area of >90% of the inner surface 24 by means of the gas flow, which is otherwise set in rotation in the same way.

FIG. 6 shows a third embodiment of the pressure charging system 1 according to the invention, which essentially differs from the second embodiment of FIG. 5 in that the inlet section 12, the center section 14 and the outlet section 16 are no longer described by simple rectilinear contours, i.e. conical and cylindrical shapes, but by more complex curved paths. Specifically, the inner cross-sectional area of the inlet section 12 continues to increase steadily along the longitudinal axis A from the inlet opening 28 to the center section 14, but now in a general manner, herein referred to as “funnel-shaped”. Similarly, the inner cross-sectional area of the outlet section 16 continues to taper along the longitudinal axis A from the center section 14 to the outlet opening 30 in a continuous and generally funnel-shaped manner. Here, too, the inner surface 24 in the inlet section 12 comprises a maximum funnel opening angle βₑ≤30°, plotted against the longitudinal axis (A), and the inner surface 24 in the outlet section 16 comprises a maximum funnel opening angle βₐ≤20°. The maximum funnel opening angles βₑ and βₐ are each formed by the angles between the tangent to the contour of the inner cross-sectional surface at the point of the largest cross-sectional increase or decrease (or mathematically the largest or smallest derivative of the curve) and the longitudinal axis A.

The center section 14 is further arranged between the inlet section 12 and the outlet section 16, wherein the boundary between the inlet section 12 and the center section 14 on the one hand and the center section 14 and the outlet section 16 on the other hand both lie in an area between the points of the largest cross-sectional increase and decrease. Also in this example, the pressure charging tank 20 comprises its maximum internal cross-sectional area 32 perpendicular to the longitudinal axis A in the center section 14.

Unlike in previously shown embodiments, the gas guiding element 34 here protrudes slightly in the downward direction beyond the inlet opening 28 into the inlet section, but is nevertheless located at least partially and even predominantly in the particle inlet 10.

FIG. 7 shows a fourth embodiment of the pressure charging system 1 according to the invention, which differs from the second embodiment of FIG. 5 only by a modified gas supply 44. In the inlet section 12, this opens into the cavity 26 tangentially to the pressure vessel wall 22, which is funnel-shaped in this case. The opening is arranged almost directly below the inlet opening in order to ensure here too that the gas flow, which is set in rotation, almost completely flushes the cavity 26 of the pressure charging tank 20. In this case, the rotation is caused by the tangential introduction and internal redirection of the gas flow along the circular cone-shaped inlet section 12.

FIG. 8 shows a fifth embodiment of the pressure charging system 1 according to the invention, which differs from the second embodiment of FIG. 5 by a modified particle inlet 50. In the inlet section 12, this inlet opens into the cavity 26 not axially, but with a radial direction component perpendicular to the here funnel-shaped pressure vessel wall 22. As in embodiments 1 to 3, the gas supply is again axial and the rotation is again effected by the gas guiding element 34.

It will be understood that the invention also includes further combinations and variants of modified particle inlets and gas supplies.

### LIST OF REFERENCE SIGNS

1 pressure charging system
2 gas flow, arrow
10 particle inlet
12 inlet section
14 center section
16 outlet section
18 particle outlet
20 pressure charging tank
22 pressure vessel wall
24 inner surface
26 cavity
28 inlet opening
30 outlet opening
32 maximum internal cross-sectional area
34 gas guiding element
36 gas guide vane
38 outer vane edge
40 outlet end (of the gas guide vane)
42 g spiral flow line
44 gas supply
50 particle inlet
A longitudinal axis
R radial direction
αₘₐₓ maximum angle of inclination
βₐ funnel opening angle of the outlet section
βₑ funnel opening angle of the inlet section

1. A pressure charging system (1) comprising a pressure charging tank (20) having a longitudinal axis (A), said pressure charging tank comprising a pressure vessel wall (22) with an inner surface (24) circumscribing a cavity (26) and having an inlet section (12), a center section (14), and an outlet section (16) along the longitudinal axis (A);
the pressure charging system (1) comprising a particle inlet (10) that defines an inlet opening (28) in the inlet section (12), and a particle outlet (18) that defines an outlet opening (30) in the outlet section (16);
wherein a gas supply (44) opening into the cavity (26) in the inlet section (12) is configured to introduce a gas flow (2) into the cavity (26) in such a way that the gas flow (2) is set into rotation about the longitudinal axis (A) in the cavity (26).

2. The pressure charging system (1) according to claim 1,
wherein the pressure charging tank (20) comprises a maximum internal cross-sectional area (32) perpendicular to the longitudinal axis (A) in the center section (14).

3. The pressure charging system (1) according to claim 1,
wherein the center section (14) is cylindrical in shape.

4. The pressure charging system (1) according to claim 1,
wherein the inlet section (12) comprises an internal cross-sectional area perpendicular to the longitudinal axis (A), which increases continuously along the longitudinal axis (A) from the inlet opening (28) to the center section (14).

5. The pressure charging system (1) according to claim 4,
wherein the inlet section (12) widens along the longitudinal axis (A) from the inlet opening (28) to the center section (14) in a funnel or cone shape.

6. The pressure charging system (1) according to claim 1,
wherein the outlet section (16) comprises an inner cross-sectional area perpendicular to the longitudinal axis (A), which decreases continuously along the longitudinal axis (A) from the center section (14) to the outlet opening (30).

7. The pressure charging system (1) according to claim 6,
wherein the outlet section (16) tapers along the longitudinal axis (A) from the center section (14) to the outlet opening (30) in the shape of a funnel or cone.

8. The pressure charging system (1) according to claim 5,
wherein the outlet section (16) tapers more acutely along the longitudinal axis (A) than the inlet section (12) widens along the longitudinal axis (A).

9. The pressure charging system (1) according to claim 1,
wherein the gas supply (44) opens into the cavity (26) through the inlet opening (28) in the inlet section (12), and wherein the gas supply (44) comprises a gas guiding element (34) arranged at least partially in the particle inlet (10).

10. The pressure charging system (1) according to claim 9,
wherein the gas guide element (34) comprises at least two gas guide vanes (36) arranged axially symmetrically about the longitudinal axis (A).

11. The pressure charging system (1) according to claim 1,
wherein the particle inlet (10) is configured as a port coaxial with the longitudinal axis (A).

12. The pressure charging system (1) according to claim 10,
wherein the gas guide vanes (36) extend in the radial direction (R) from the longitudinal axis (A) to an inner surface of the particle inlet (10), wherein they form an outer vane edge (38) along the inner surface of the particle inlet (10), which is inclined at least in sections with respect to the direction of the longitudinal axis (A).

13. The pressure charging system (1) according to claim 12,
wherein the outer vane edge (38) forms a curved curve with an angle of inclination increasing in a direction from the inlet opening (28) to the outlet opening (30) with respect to the longitudinal axis (A).

14. The pressure charging system (1) according to claim 13,
wherein a maximum angle of inclination (αmax) of the outer vane edge (38) at its end (40) on the outlet side in the axial direction is ≥30°, 40°, or ≥45°, relative to the longitudinal axis (A).

15. The pressure charging system (1) according to claim 1,
wherein the gas supply (44) is configured to introduce a rotating gas flow (2) generating a shear stress of at least 1 Pa, at least 5 Pa, or at least 10 Pa over an area of at least 80%, at least 85%, or at least 90% of the inner surface (24) and at a distance of 1 mm from the inner surface (24).

16. The pressure charging system (1) according to claim 1,
wherein a gas pressure source connectable to the gas supply (44) is provided, which is configured to provide a gas flow under an inlet pressure P of 3 to 12 bar, or 6 to 10 bar.

17. The pressure charging system (1) according to claim 16,
wherein the gas pressure source is configured to provide a gas flow with a mass flow S of 20 kg/s to 100 kg/s.

18. The pressure charging system (1) according to claim 16,
wherein the gas pressure source is configured to provide the gas flow for at least 0.5 seconds, preferably at least 1 second.

19. The pressure charging system (1) according to claim 16,
wherein the gas pressure source comprises a gas pressure accumulator.

20. A method for cleaning a pressure charging tank (20) comprising a longitudinal axis (A), the pressure charging tank comprising a pressure vessel wall (22) with an inner surface (24) circumscribing a cavity (26) and having along the longitudinal axis (A) an inlet section (12), a center section (14), and an outlet section (16), the method comprising introducing a gas flow (2) into the cavity (26) in the inlet section (12), wherein the gas flow (2) is set into rotation about the longitudinal axis (A) in the cavity (26).

21. The method according to claim 20,
wherein a shear stress of at least 1 Pa, at least 5 Pa, or at least 10 Pa is generated by means of the rotating gas flow over an area of at least 80%, at least 85%, or at least 90% of the inner surface (24) and at a distance of 1 mm from the inner surface (24).
